(19) United States
(12) Patent Application Publication
(10) Pub. No.: US 2006/0223440 A1
(43) Pub. Date: Oct. 5, 2006

(54) Low frequency noise source and method of calibration thereof

(76) Inventor: David Stockton, Dunfermline (GB)

Correspondence Address: AGILENT TECHNOLOGIES INC.;INTELLECTUAL PROPERTY ADMINISTRATION, LEGAL DEPT,, M/S DU404, P.O. BOX 7599, LOVELAND, CO, 80537-0599, US

(21) Appl. No.: 11/096,306

(22) Filed: Apr. 1, 2005

(51) Int. Cl. H04B 1/00; H04B 15/00

(52) U.S. Cl. 455/63.1

(57) ABSTRACT

A low frequency noise source includes a digital section having a controller, a low frequency noise generator coupled to the controller, a calibration waveform generator coupled to the controller, and a switch coupled to outputs of the noise generator and the calibration waveform generator for selectively coupling one of them to a Digital to Analog Converter (DAC) having an output coupled to an analog output interface. The low frequency noise source is controlled by a noise figure measuring instrument and an ac power meter is used to measure the output of the low frequency noise source so that it can be calibrated prior to be using used for measuring noise figures for devices to be tested.

### FIELD OF THE INVENTION

The present invention relates to a low frequency noise source and to a method of calibrating the low frequency noise source, especially, though not exclusively, to produce a calibrated low frequency noise source which can be used with current noise measurement techniques.

### BACKGROUND OF THE INVENTION

Some of the latest wireless telecommunications devices, such as cellular telephones and wireless computer networking interfaces, and, in particular, Wireless Local Area Network (LAN) Interfaces, exploit simplified receiver architectures to lower their cost. It is now commonplace for a single “front-end” device to receive a signal in the GHz frequency range and to convert this frequency to an intermediate frequency (IF) near, or straddling, zero Hertz. In this regard, it should be noted that the concept of negative frequency is can be used where a signal is resolved into a pair of orthogonal components.

The level of unwanted random noise created in an entire receiver or in a component part of a receiver is an important performance parameter and has also been used as an overall figure of merit. There are several ways of numerically expressing noise contributions. For radio frequency (RF) equipment it is common to model all noise contributions together as a single equivalent input and to express its level either as a decibel ratio with respect to thermal noise of a reference temperature (the conventional reference temperature is 290 Kelvin), or else as an equivalent thermal noise temperature. The decibel ratio is called the “Noise Figure” and conversion between the Noise Figure value and the equivalent thermal noise temperature is a simple one.

When a device is being tested, its noise contribution can only be measured at its output, but convention requires an equivalent input level to be calculated. To do this the gain, or loss, of the device must also be measured.

There are several methods of measuring the Noise Figure. The most common method which can be used at RF and Microwave frequencies (historically known as “The Y factor method”), uses a calibrated noise source that covers the frequency range of interest. Such a calibrated noise source has to operate at two different output levels. One of these levels is usually the thermal noise contribution of the noise source's output impedance due to its finite temperature. The other (higher) level is caused by the operation of an electrically powered noise generator, such as a specialised semiconductor diode, biased into a controlled-current avalanche condition.

The calibrated noise source feeds the input of a Device Under Test (DUT). The output of the DUT is measured using a frequency-selective measuring receiver. By having two different calibrated noise levels, the measuring receiver does not have to measure absolute power; it only needs to make an accurate measurement of the ratio of the two noise levels. The solution of a pair of simultaneous equations yields the Noise Figure of the DUT combined with the measuring receiver. If it is known that the gain and noise performance of the DUT makes the noise contribution of the measuring receiver insignificant, then this result may be sufficient. Otherwise, further calculations are necessary, as described following.

By making a second pair of measurements, with the noise source directly applied to the input of the measuring receiver, the noise performance and sensitivity of the measuring receiver can be calculated. Combining this with the first pair of measurements gives enough information to allow the Noise Figure and gain of the DUT to be calculated. Measurements where the measuring receiver contributions have been removed are usually termed “Second-stage corrected” measurements.

When the device being measured is a mixer, or any device that performs frequency translation, the input and output frequencies are different. The noise source applied to the input port of the DUT must therefore cover the frequency range needed at that port. The noise source used to make the correction measurements of the measuring receiver must cover the frequency range of the output of the DUT, i.e. the frequency range that the measuring receiver is tuned to.

Historically, Noise Figure measurement has been important across the range from VHF (Very High Frequencies) up to microwave frequencies (from approximately 30 MHz to 100 GHz). In fact, most measuring receivers and noise sources are designed and specified for operation above 10 MHz.

The very low output frequencies of modern “zero IF” and “near-zero IF” wireless front-end devices are outside the range of existing noise figure measurement receivers or instruments. New noise figure measurement instruments, particularly spectrum analysers with built-in noise figure measurement capability, are becoming available, and can now perform to very low frequencies. Typically, spectrum analysers have higher levels of contributed noise than the older dedicated noise figure measurement instruments. The ability to make “second-stage corrected” measurements is therefore of increasing importance.

To make a second-stage corrected measurement, a calibrated noise source is still necessary, and it must now cover the lower frequency ranges involved. The ideal would be a single noise source covering all necessary frequencies. In practice, this is too wide a range to be covered by a single technique and therefore a separate low-frequency noise source is desirable to complement the currently available RF and microwave noise sources.

Semiconductor noise diodes can be used across a frequency range from 10 MHz to over 100 GHz, but exhibit problems at lower frequencies. Digital techniques have become the normal way of creating low-frequency noise. Noise from physical processes, such as an avalanche noise diode, is genuinely random. Digitally-created noise is predictable, as well as being repeatable, and so is referred to as “pseudo-random” noise. Provided that the digital sequence is long enough that the repetition frequency is small compared to the bandwidth of the measuring receiver, digitally created noise is indistinguishable from the diode and thermal noise sources used in Noise Figure measurements.

Digital signal creation instruments, capable of making pseudo-random noise and a variety of other waveforms, are commonplace. Using such an instrument directly for such a purpose requires two problems to be overcome. Firstly, the noise source has to be put under the control of the measuring receiver, and secondly, the levels of the output noise have to be calibrated to very high accuracy, by a method that makes them traceable to national standards laboratories.

RF/microwave noise sources currently in use are calibrated by comparison with similar noise sources that are kept in calibration laboratories. These noise sources are known as “transfer standards” and are calibrated at national standards laboratories by comparison with precision thermal noise sources and are periodically re-tested. The primary standards equipment and comparison equipment at the national laboratories were developed to serve the calibration needs of existing RF/microwave noise sources, with no requirements to operate below 10 MHz. The calibration infrastructure needed to support low-frequency noise sources of the precision needed for Noise Figure measurement does not yet exist.

Some existing thermal primary noise standards are already suitable for low-frequency use, but require calibration for their use to be extended below 10 MHz.

Precision receivers are used for comparing a source being calibrated against a standard source and their use at low frequencies poses great difficulties. The requirement to have a very small measurement uncertainty means that their contribution to the noise levels must be low. A low noise contribution by an amplifier used in a controlled-impedance system normally occurs when the input signal is a significant mis-match to its source impedance. Therefore the input impedance of low-noise receivers is poorly matched to their input signals and this creates a further source of uncertainty. At RF and microwave frequencies, this problem is normally solved by using non-reciprocal isolators to pass incoming signals, but also to absorb reflections from the receiver preamplifiers. This presents a more uniform and accurate impedance to the signal source. Isolators are ferromagnetic devices whose physical sizes are related to the wavelengths they cover and they are impractical at low frequencies.

The present invention therefore seeks to provide a low frequency noise source and a method for the calibration of that low frequency noise source, specifically so that it can be used with current measurement techniques, so as to overcome, or at least reduce the above-mentioned problems of the prior art.

### BRIEF SUMMARY OF THE INVENTION

Accordingly, in a first aspect, the invention provides a low frequency noise source, comprising a control input for receiving control signals, a digital section comprising a controller having a bi-directional control interface coupled to the control input, a low frequency noise generator coupled to the controller and having an output, a calibration waveform generator coupled to the controller and having an output, a switch coupled to the outputs of the noise generator and the calibration waveform generator for selectively coupling one of the outputs of the noise generator and the calibration waveform generator to an output of the digital section, a Digital to Analog Converter (DAC) having an input coupled to the output of the digital section and an output, and an analog output interface having an input coupled to the output of the DAC and an output coupled to an output of the low frequency noise source.

In one embodiment, the analog output interface comprises a low-pass filter. The analog output interface may also comprise at least one attenuator for buffering the effects of the low-pass filter.

The controller may comprise a non-volatile memory device for storing identity and calibration information and may further comprise further memory for storing wave form files.

In an embodiment, the calibration waveform generator generates a calibration waveform chosen to be a sine wave of programmable frequency and amplitude.

The low frequency noise generator may comprises a pseudo-random noise generator. A temperature sensor for measuring the temperature of the analog output interface may also be provided, which may located close to the analog interface output.

According to a second aspect, the invention provides a low frequency noise source calibration system comprising a low frequency noise source as described above, a noise figure measurement instrument coupled to the control input of the low frequency noise source and an AC calibrated power meter coupled to the output of the low frequency noise source.

In a third aspect, the invention provides a method for calibrating a low frequency noise source as described above, wherein the method comprises the steps of controlling the calibration wave generator to generate a predetermined waveform, switching the output of the calibration wave generator to provide the output of the digital section of the low frequency noise source, measuring the output of the low frequency noise source using a calibrated precision AC power meter across a range of frequencies and levels of the output predetermined waveform, in order to determine characteristics of the DAC and analog output interface, measuring output impedance at the output of the low frequency noise source, deriving the output noise level versus frequency characteristics of the low frequency noise source using pre-existing knowledge of the digital noise signal combined with the measured characteristics of the DAC and analog output interface, calculating a calibration table using the derived output noise level versus frequency characteristics.

In one embodiment, the method further comprises the step of correcting for errors due to imperfect output impedance by calculation.

The method may further comprise the step of performing uncertainty calculations for the noise level calibration at each different frequency in the calibration table using the specification of the calibrated AC power meter.

### BRIEF DESCRIPTION OF THE DRAWINGS

One embodiment of the invention will now be more fully described, by way of example, with reference to the drawings, of which:

FIG. 1 shows a diagram of a low-frequency noise source according to one embodiment of the present invention;

FIG. 2 shows a diagram of a conventional microwave noise source and a noise figure measurement instrument being used to measure a low output frequency down-converting DUT; and

FIG. 3 shows a diagram of a low frequency noise source being used to measure the sensitivity and noise of the noise figure measurement instrument alone, so that the noise and gain contributions of just the DUT can be calculated, according to one embodiment of the present invention.

### DETAILED DESCRIPTION OF THE DRAWINGS

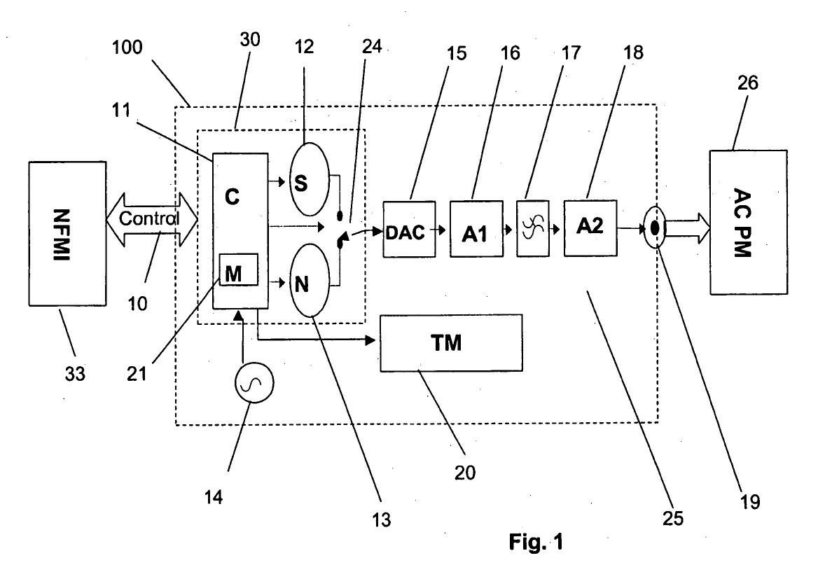

In FIG. 1 there is shown a diagram of a low frequency noise source 100 that can be more easily and accurately calibrated and will operate under the direct control of modern noise figure measurement systems, according to one embodiment of the present invention.

The low frequency noise source 100 comprises: a digital section 30, an analogue section 25, a digital-to-analogue converter (DAC) 15, a temperature measurement device 20 and a clock oscillator 14. Power supplies are not shown.

The clock oscillator 14 provides timing information to all sections of the low frequency noise source, either directly or indirectly.

The low frequency noise source 100 is controlled by a suitable Noise Figure Measurement Instrument (NFMI) 33, such as a spectrum analyser with built-in noise figure measurement capability, via a bi-directional control interface 10. The bi-directional control interface 10 could be a RS-232 interface or any other suitable interface known in the art, for example a two-wire bus arrangement.

The digital section 30 of the low frequency noise source 100 comprises a controller 11, a noise generator 13 and a calibration waveform generator 12. The output of either can be selected and fed into the DAC 15 via a switch 24.

The controller 11 stores control data from the noise figure measurement instrument 33. The noise figure measurement instrument 33 sets the operational mode of the low frequency noise source 100 along with frequency, amplitude and wave shape parameters. The controller 11 additionally contains a non-volatile memory device 21 for the purpose of storing identity and calibration information, which is accessible via the bi-directional control interface 10. The controller 11 provides an interface for a digital temperature measurement device 20 so that the noise figure measurement instrument 33 can read the temperature of the analogue section 25 for use in its calculations. The controller 11 may include further memory for storing programs (not shown).

As described earlier, either the output from the noise generator 13 or from the calibration waveform generator 12 can be selected and fed into the DAC 15 via the switch 24. In this embodiment, the calibration waveform is chosen to be a sine wave of programmable frequency and amplitude, but it could also be in the form of a square wave. The two waveform generators may either be implemented as a single combined function, or may be two separate functions in order to optimise the efficiency of the digital section 30. A waveform file could also be downloaded from the noise figure measurement instrument 33 to the low frequency noise source 100 via the bi-directional control interface 10 into the memory 21 of the controller 11.

The calibration waveform generator 12 is a conventional digital arbitrary waveform generator which creates an output representing a low frequency sampled sine wave.

The DAC 15 receives a series of data inputs representing a low frequency sampled waveform from the selected waveform generator and converts it into a sampled analogue waveform. An attenuator A1 16 may be provided in the analogue section 25 to buffer the DAC 15 from the input impedance variations over frequency of a low-pass anti-alias filter 17. The low-pass anti-alias filter 17 performs waveform re-construction by attenuating clock and alias related components from the signal. Another attenuator A2 18 may be provided to buffer the output connector 19 from the effects of output impedance variations over frequency of the low-pass anti-alias filter 17.

The noise or calibration signal leaves the low frequency noise source 100 via the output connector 19. A precision AC Power Meter (AC PM) 26 covering the frequency range of the low frequency noise source 100 is shown connected to the output connector 19 and can be used for calibration purposes, as will be described further below.

In normal use, the noise generator 13 is selected and the noise figure measurement instrument 33 uses the bi-directional control interface 10 and the controller 11 to turn the intentionally generated noise on and off in the normal manner for “Y-factor” method Noise Figure measurements. When the noise generator 13 is switched off, the output noise level does not fall to zero, but to a thermal noise floor caused by the thermal creation of random noise in the resistances of the analogue section 25 and of the DAC 15. This level is predictable from the Maxwell-Boltzmann constant, if the temperature of these parts is known. The temperature measurement device 20 is located close to analogue section 25 and the DAC 15 to allow the noise figure measurement instrument 33 to read the temperature of the analogue section 25 via the controller 11, and thereby calculate the thermal noise floor in the “off” state.

When the noise generator 13 is switched on, the thermal noise just described still exists, and a larger level of intentionally created noise is added to the output. The level of this added noise, measured at a chosen number of calibration frequencies, is stored in the non-volatile memory 21 of the controller 11. The noise figure measurement instrument 33 reads this data via the bi-directional control interface 10 and uses it in its calculations.

The calibration data of the low frequency noise source 100 is critically important to noise figure measurements and is how the accuracy of a measurement is traceable to accepted national and international standards. The calibration data for each individual low frequency noise source 100 must be determined before it can be first used. The calibration process must be repeated annually or at some other chosen period and the calibration data updated.

During the calibration process, the switch 24 routes data from the calibration wave generator 12 to the DAC 15. The data from the calibration wave generator 12 is precisely calculable. The signal at the output connector 19 therefore provides information from which the DAC 15 and analogue section 25 can be characterised by the precision AC power meter 26. The precision AC power meter 26 must be calibrated in a way traceable to national standards laboratories. By taking measurements across a range of frequencies and levels of the output sine wave, the DAC 15 and analogue section 25 may be characterised as thoroughly as is necessary. Measurement of the output impedance at the output connector 19, allows errors due to imperfect output impedance to be corrected by calculation.

The noise created by the noise generator 13 is precisely calculable and repeatable. It is pseudo-random, not truly random. By combining this knowledge of the digital noise signal with the accurately measured characteristic of the DAC 15 and analogue section 25, the output noise level versus frequency can be derived. From this, the data for the calibration table can be calculated, and from the specification of the calibrated power meter, uncertainty calculations may be performed for the noise level calibration at each different frequency in the calibration table.

In normal use, the noise generator 13 operates and provides data to the DAC 15 via the switch 24. The noise generator 13 accepts control signals from the controller 11 to select pseudo random sequences, clock division factors, amplitude scaling factors and a noise on/off control coming directly from the noise figure measurement instrument 33. The DAC 15 converts the digital signal from the switch 24 into a pseudo-random analogue noise voltage.

Digital noise generators are known in the art and variants exist to make noise with a variety of characteristics. In this embodiment, white noise with an approximated Gaussian probability density function may be chosen. This embodiment also uses a calibration wave generator 12 to create the repetitive signals that can be used in this embodiment of the present invention to calibrate the noise output level.

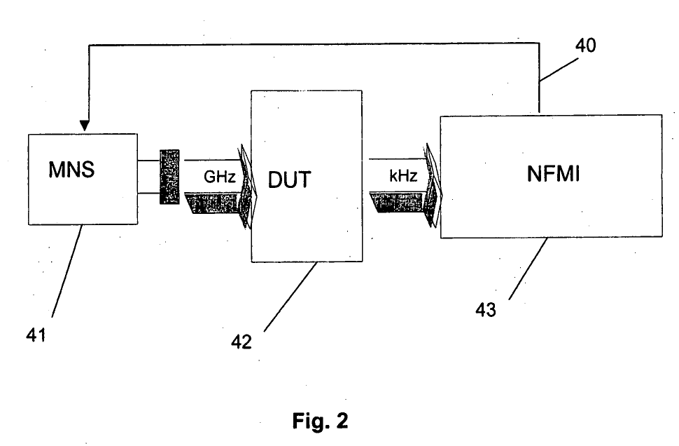

FIG. 2 shows a simple known noise figure measurement being performed on a DUT 42. In this case the DUT 42 may be, for example, a modern wireless front end device. Its input frequency band is in the GHz range, and its output band is in the kHz range. An existing Microwave Noise Source (MNS) 41 generates noise at a calibrated level to feed to the input of the DUT 42. Also shown is a communications link 40, whereby a Noise Figure Measurement Instrument (NFMI) 43 can turn the microwave noise source 41 on and off, as is needed for the “Y-factor” measurement method. The low output frequency of the DUT 42 requires the use of a Noise Figure Measurement Instrument 43 with low frequency capability, such as a spectrum analyser.

This simple measurement system measures the aggregate noise contributions of the DUT 42 plus those of the Noise Figure Measurement Instrument 43. This measurement is often unsatisfactory, because there is no segregation between the noise of the DUT 42 and the noise of the noise figure measurement instrument 43. Under special circumstances, the DUT 42 may be dominant, such that the noise from the Noise Figure Measurement Instrument 43 may be neglected, making this simple measurement useful.

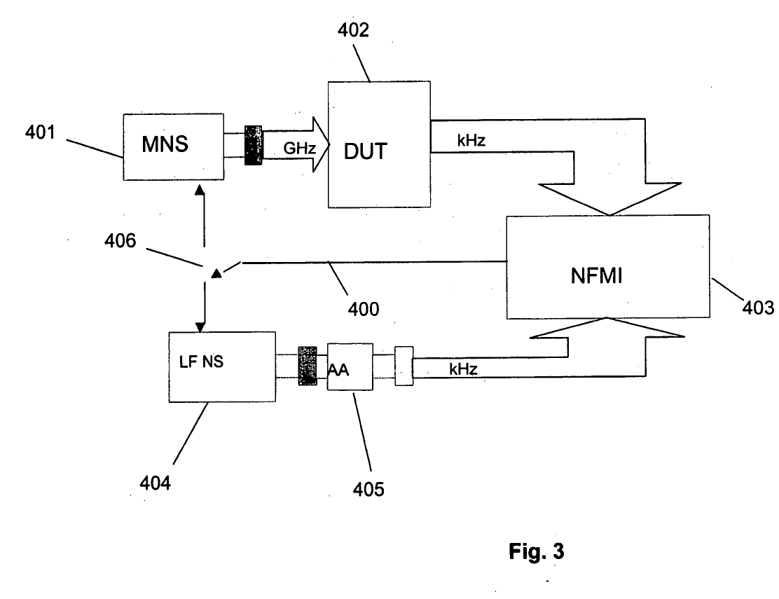

FIG. 3 shows a system for carrying out a “Second stage corrected measurement”. It involves two operations. The first operation is to characterise the Noise Figure Measurement Instrument 403 using a suitable calibrated Low Frequency Noise Source 404, such as that described above according to one embodiment of the present invention. The second operation is to measure the noise figure for the DUT 402. This second operation differs from the measurement operation described above with reference to FIG. 2 only in the use of the data from the first operation in the final calculations.

The DUT 402 used in the set-up as shown in FIG. 3 should be the same as the DUT 42 used in the set-up as shown in FIG. 2. Its output frequency range requires a low frequency Noise Figure Measurement Instrument 403 such as a spectrum analyser. In making the reference measurement for a second stage corrected measurement, the DUT 402 and the microwave noise source 401 are not involved. A Low Frequency Noise Source (LF NS) 404 is needed to measure the noise and sensitivity performance of the Noise Figure Measurement Instrument 403. The Noise Figure Measurement Instrument 403 controls the Low Frequency Noise Source 404 via an interface cable 400 switched to the Low Frequency Noise Source 404 via switch 406 and turns its noise output alternately on and off in the normal way for Y-factor noise measurement. It is essential that the noise figure measuring instrument 403 is operated with the same signal level range settings as will be used with the DUT 402 connected in the second part of the measurement process.

An attenuator 405 may be included to reduce the noise level of the Low Frequency Noise Source 404 to a level appropriate to the signal level range setting of the Noise Figure Measurement Instrument 403.

In this embodiment of the invention, the noise output level of the Low Frequency Noise Source 404 is chosen to be at a high level to facilitate calibration using standard laboratory instruments without needing added amplification. In use, this level will be too high for most applications and a high-value attenuator 405 will be needed as an ancillary on the output of the Low Frequency Noise Source 404.

The attenuator 405 may be viewed as a part of the Low. Frequency Noise Source 404 and calibrated against a traceably calibrated network analyser whenever the Low Frequency Noise Source 404 is calibrated. Calibration data for the calibrated attenuator 405 may be stored in the memory of the Low Frequency Noise Source 404.

Once the Noise Figure Measurement Instrument 403 is properly calibrated, it is switched by switch 406 to control the Microwave Noise Source (MNS) 401 with the DUT 402 connected to the Noise Figure Measurement Instrument 403 for the second part of the “second stage corrected measurement”, to be performed as described above with reference to FIG. 2.

It will be appreciated that although only one particular embodiment of the invention has been described in detail, various modifications and improvements can be made by a person skilled in the art without departing from the scope of the present invention. For example, although in FIG. 3, the noise figure instrument is shown as having two inputs coupled to receive kHz outputs from both the DUT 402 and the Low Frequency Noise Source 404 (via the calibrated attenuator 405), it will be clear to a person skilled in the art that normal practice in RF noise figure measurement would be to connect up the two arrangements at different times to an instrument with a single input and such an arrangement should be taken to be an alternative to the one shown in the Figure.

1. A low frequency noise source, comprising:
a control input for receiving control signals;
a digital section comprising
a controller, having a bi-directional control interface coupled to the control input,
a low frequency noise generator coupled to the controller and having an output,
a calibration waveform generator coupled to the controller and having an output,
a switch coupled to the outputs of the noise generator and the calibration waveform generator for selectively coupling one of the outputs of the noise generator and the calibration waveform generator to an output of the digital section;
a Digital to Analog Converter (DAC) having an input coupled to the output of the digital section and an output; and
an analog output interface having an input coupled to the output of the DAC and an output coupled to an output of the low frequency noise source.

2. A low frequency noise source according to claim 1, wherein the analog output interface comprises a low-pass filter.

3. A low frequency noise source according to claim 2, wherein the analog output interface comprises at least one attenuator for buffering the effects of the low-pass filter.

4. A low frequency noise source according to claim 1, wherein the controller comprises a non-volatile memory device for storing identity and calibration information.

5. A low frequency noise source according claim 1, wherein the controller further comprises further memory for storing wave form files.

6. A low frequency noise source according to claim 1, wherein the calibration waveform generator generates a calibration waveform chosen to be a sine wave of programmable frequency and amplitude.

7. A low frequency noise source according to claim 1, wherein the low frequency noise generator comprises a pseudo-random noise generator.

8. A low frequency noise source according to claim 1, further comprising a temperature sensor for measuring the temperature of the analog output interface.

9. A low frequency noise source according to claim 8, wherein the temperature sensor is located close to the analog interface output.

10. A low frequency noise source calibration system comprising a low frequency noise source according to claim 1, a noise figure measurement instrument coupled to the control input of the low frequency noise source and an AC calibrated power meter coupled to the output of the low frequency noise source.

11. A method for calibrating a low frequency noise source according to claim 1, wherein the method comprises the steps of:
controlling the calibration wave generator to generate a predetermined waveform;
switching the output of the calibration wave generator to provide the output of the digital section of the low frequency noise source;
measuring the output of the low frequency noise source using a calibrated precision AC power meter across a range of frequencies and levels of the output predetermined waveform, in order to determine characteristics of the DAC and analog output interface;
measuring output impedance at the output of the low frequency noise source;
deriving the output noise level versus frequency characteristics of the low frequency noise source using pre-existing knowledge of the digital noise signal combined with the measured characteristics of the DAC and analog output interface;
calculating a calibration table using the derived output noise level versus frequency characteristics.

12. A method for calibrating a low frequency noise source according to claim 11, further comprising the step of correcting for errors due to imperfect output impedance by calculation.

13. A method for calibrating a low frequency noise source according to claim 11, further comprising the step of performing uncertainty calculations for the noise level calibration at each different frequency in the calibration table using the specification of the calibrated AC power meter.
